(19) United States
(12) Patent Application Publication
(10) Pub. No.: US 2012/0131790 A1
(43) Pub. Date: May 31, 2012

(54) CAM GRINDING DEVICE

(76) Inventor: Roland Schacherer, Geisingen (DE)

(21) Appl. No.: 13/376,020

(22) PCT Filed: May 28, 2010
(86) PCT No.: PCT/EP10/57472

§ 371 Date: Feb. 16, 2012

(30) Foreign Application Priority Data
Jun. 2, 2009 (DE) 10 2009 023 612.0

(51) Int. Cl. B23P 13/04; B23B 25/00

(52) U.S. Cl. 29/557; 29/28

(57) ABSTRACT

A device for grinding cams for a camshaft may include at least one retaining mandrel on which the cams may be non-rotatably fixed during the grinding operation, and wherein the at least one retaining mandrel may be formed at least in certain regions from ceramic.

The present invention relates to a device for grinding cams for a camshaft and also to a process for grinding cams of a camshaft using such a grinding device.

Cams for camshafts, in particular camshafts for internal combustion engines, generally have to be ground in order to make it possible for the associated valves to be operated as accurately and exactly as possible. To date, this has been done by means of so-called camshaft grinding devices, in which the cams to be ground are clamped on a metallic retaining mandrel, e.g. a hydraulic expansion mandrel, and it is thereby possible to grind a plurality of cams arranged axially parallel to one another. It is disadvantageous in this respect, however, that such a metallic retaining mandrel can elastically sag during grinding of the cams, which leads to inaccurate grinding of the individual cams. At the same time, such a metallic retaining mandrel is subjected to wear which is not to be underestimated, and accordingly has to be replaced regularly, and this likewise increases the grinding costs for each cam to be ground. Since, in addition, only at most four cams can usually be received at the same time per retaining mandrel, and each cam requires a grinding time of, for example, 15 seconds, 60 seconds are therefore needed in total for grinding four cams. On account of the sagging of the metallic retaining mandrel, and the associated or subsequent grinding inaccuracies, it is only possible to simultaneously grind the four cams when grinding is carried out with a relatively low grinding pressure, as a result of which the grinding time increases in turn.

The present invention addresses the problem of specifying an improved embodiment for a device for grinding cams for a camshaft which, in particular, makes it possible to grind the cams more cost-effectively.

According to the invention, this problem is solved by the subjects of the independent claims. The dependent claims relate to advantageous embodiments.

The present invention is based on the general concept, in the case of a device known per se for grinding cams for a camshaft, in particular for a camshaft of an internal combustion engine, of replacing a retaining mandrel which, to date, has been in the form of a metallic expansion mandrel with a retaining mandrel which is formed at least in certain regions, preferably entirely, from ceramic. In this respect, it is possible to use, in particular, so-called industrial ceramics. The major advantage of such a retaining mandrel formed from ceramic is, in particular, the very high modulus of elasticity of the ceramic, which makes the retaining mandrel so rigid that it also makes it possible for at least four cams clamped on the ceramic retaining mandrel to be simultaneously ground, as a result of which the grinding time and therefore the grinding costs for each cam can be reduced considerably. As a result of the high modulus of elasticity and the high rigidity, such a retaining mandrel designed according to the invention additionally does not require any support whatsoever, and is nevertheless able to receive as many cams for grinding as or more cams for grinding than a retaining mandrel known to date which is formed from metal, in particular from steel. A high coefficient of friction, which is characteristic of ceramic, in particular of industrial ceramic, additionally leads to considerably improved adhesion of the cams on the ceramic retaining mandrel, as a result of which it is possible to transmit a torque from the ceramic retaining mandrel to the cams to be ground more effectively during grinding of the latter. It is further particularly advantageous that the thermal expansion of ceramic is merely approximately 25% that of steel, such that the cams which are joined, by way of example thermally, to the respective retaining mandrel, in particular to the ceramic retaining mandrel, can be braced considerably more effectively thereon and, after the grinding operation, can also be removed therefrom considerably more easily. The cams are removed after the grinding operation by heating, for example by inductively heating, the respective cam, which expands as a result and can thus be easily removed from the ceramic retaining mandrel, which cannot be inductively heated. By inductively heating the cams, only the latter are heated, but not the ceramic retaining mandrel, and therefore the retaining mandrel can only be heated via the transfer of heat of the cams to the retaining mandrel and therefore to only a very small extent, and the heating does not have a negative effect on the process for removing the cams from the retaining mandrel.

Since ceramic materials, in particular so-called industrial ceramics, additionally have a considerably higher creep resistance than metals, the ceramic retaining mandrel according to the invention can be used for a much longer period of time than a comparable metallic retaining mandrel, and it is thereby likewise possible to reduce costs. It is of course also conceivable here for the retaining mandrel according to the invention to be formed only in certain regions from ceramic, rather than completely. The relatively long service life and the high modulus of elasticity in particular make it possible to significantly reduce the grinding costs with respect to the individual cams.

In an advantageous development of the solution according to the invention, the at least one retaining mandrel is formed at least in certain regions from a nitride ceramic, which additionally comprises silicon and in particular is in the form of Si₃N₄. Silicon nitride (Si₃N₄) plays a presently clearly dominant role among the nitride ceramics and has a combination of outstanding material properties which, to date, has not been achieved by other ceramics, these properties including, inter alia, a high toughness, a high strength even at high temperatures, an outstanding thermal shock resistance, an outstanding wear resistance, low thermal expansion, a merely average thermal conductivity and also a high chemical resistance. This combination of properties gives a ceramic which withstands the most extreme conditions of use and, in particular, is predestined for machine components with very high dynamic loading and reliability demands. The production of relatively dense silicon nitride ceramics is carried out on the basis of a submicron Si₃N₄ powder, which is mixed with sintering additives (Al₂O₃, Y₂O₃, MgO, etc.) and, after the shaping process, is sintered at temperatures of between 1750 and 1950° C. Since Si₃N₄ decomposes at temperatures above about 1700° C. under normal pressure of the sintering atmosphere, the N₂ pressure can be increased during the sintering and the decomposition can thereby be counteracted.

Further important features and advantages of the invention emerge from the dependent claims, from the drawing and from the associated description of the figures with reference to the drawing.

It should be understood that the features mentioned above and the features still to be explained hereinbelow can be used not only in the combination given in each case, but also in other combinations or on their own, without departing from the scope of the present invention.

A preferred exemplary embodiment of the invention is shown in the drawing and will be explained in more detail in the following description.

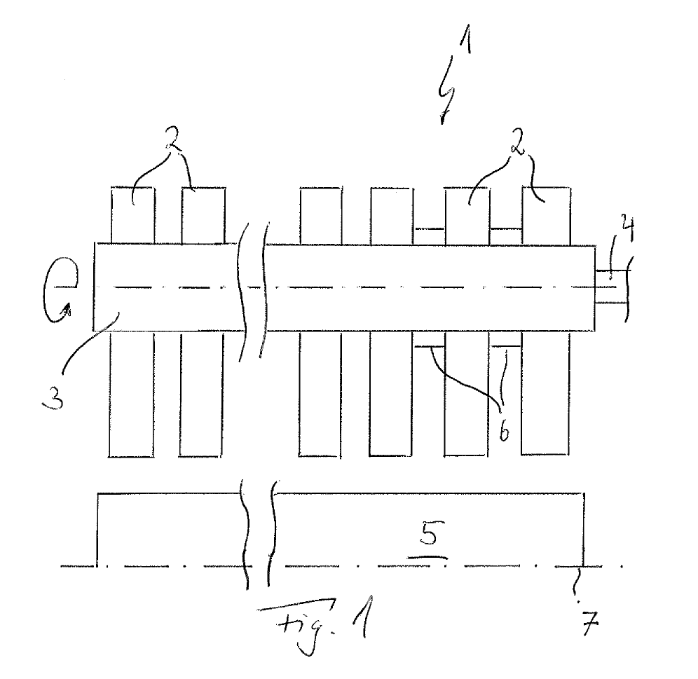

The only FIGURE, FIG. 1, shows a highly diagrammatic illustration of a grinding device according to the invention for grinding cams for camshafts.

As shown in FIG. 1, a device 1 according to the invention for grinding cams 2 has a retaining mandrel 3 on which the cams 2 are non-rotatably fixed during a grinding operation. According to the invention, this retaining mandrel 3 is formed at least in certain regions, preferably predominantly, from ceramic, in particular from an industrial ceramic. In this case, the retaining mandrel 3 is non-rotatably connected to a shaft 4 of a drive device (not shown). Since, according to the invention, the retaining mandrel 3 is formed from ceramic, said mandrel has a high modulus of elasticity and, associated with this, a high strength. This makes it possible to simultaneously grind a plurality of cams 2, preferably for example eight cams 2, by pressing these against a grinding element 5 of the device 1. The grinding element 5 itself usually has a rapidly rotating grinding body, which is pressed against the cams 2 clamped on the retaining mandrel 3. It goes without saying that the retaining mandrel 3 can also be pressed against the grinding element 5. It is also conceivable for the grinding element itself to be in the form of a grinding disk, which is intended to be illustrated by an axis of rotation 7 according to FIG. 1.

In contrast to previous retaining mandrels formed from metal, it is possible with the retaining mandrel 3 according to the invention, which is formed from ceramic, to simultaneously grind a multiplicity of cams 2, since the retaining mandrel 3 according to the invention experiences virtually no sagging during the grinding operation on account of its high strength, and thereby makes it possible for a plurality of cams 2 to be simultaneously exactly ground. In contrast thereto, using a retaining mandrel from the prior art which is formed from metal, it is merely possible to grind the cams 2 in succession or to grind at most four cams 2 at the same time, the latter with a relatively low grinding pressure, as a result of which the grinding operation as a whole is prolonged significantly. On account of the high rigidity, strength and the high modulus of elasticity, it is also the case that the retaining mandrel 3 according to the invention does not require any further support and, even though it does not require this support, does not experience unacceptable bending, which would have a negative effect on a grinding result.

In contrast to known metallic retaining mandrels, the ceramic retaining mandrel 3 according to the invention additionally has a considerably lower thermal expansion and a considerably improved coefficient of friction, both of which contribute to an overall simplification of the grinding operation. The cams 2 are usually arranged on the retaining mandrel 3 with a form fit and/or force fit, for which purpose at least certain regions of the outer side, for example, of the retaining mandrel 3 are knurled, in particular are provided with a multi-toothed profile, or have a tongue/groove connection. Such possible knurling improves interlocking with the cams 2 to be ground and thereby the transmission of a torque between the cams 2 and the retaining mandrel 3. As an alternative to this, it is also conceivable for the cams 2 to be ground to be thermally joined to the retaining mandrel 3, for which purpose the cams 2 are firstly heated and, in the heated state, are pushed or pressed onto the retaining mandrel 3. After cooling and accompanying shrinkage, the cams 2 are non-rotatably fixed to the retaining mandrel 3 without a form fit.

In this respect, it is particularly advantageous that the cams 2 can firstly be machined with respect to their borehole, can then be inductively heated and can be threaded onto the ceramic retaining mandrel 3. Even if the borehole were not to be made exactly, this would not have a negative influence on the later operation of the cam 2, since the cam 2 with a “crooked” borehole is firstly thermally connected to the retaining mandrel 3 and then ground. By renewed inductive heating, the cam 2 is removed from the retaining mandrel 3 and threaded, preferably without cooling and intermediate storage, onto the camshaft of the internal combustion engine, on which said cam then shrinks “firmly” by cooling. Since no change is made to the borehole, following shrinkage the cam 2 adopts the same position on the camshaft as on the retaining mandrel 3, i.e. the same snug fit, and is therefore likewise oriented in terms of its ground surface in a manner identical to its orientation on the retaining mandrel 3.

Alternatively, it is of course also conceivable for the cams 2 to be ground to be braced on the retaining mandrel 3, in particular via spacer rings 6 which lie between the individual cams 2 in the axial direction and of which merely two are shown by way of example in FIG. 1. It is clear that only a single retaining mandrel 3, which is additionally interrupted in the axial direction, is shown in FIG. 1, it being clear of course that the device 1 according to the invention for grinding cams 2 for a camshaft can also have a plurality of retaining mandrels 3.

According to an advantageous development of the solution according to the invention, the at least one retaining mandrel 3 is formed at least in certain regions from a nitride ceramic. In addition, this nitride ceramic can comprise silicon and in particular can be in the form of Si₃N₄. In this case, reference is made to silicon nitride, which has a high toughness, a high strength even at high temperatures, an outstanding thermal shock resistance, an outstanding wear resistance, low thermal expansion, an average thermal conductivity and also a high chemical resistance.

To date, such retaining mandrels were designed, by way of example, as hydraulic shafts, which have inner chambers that are arranged in the region of the cams 2 and into which hydraulic liquid has been pressed in order to non-rotatably fix the outer cams 2 by expansion of the shaft. However, such hydraulic shafts were relatively expensive, could not be readily removed from the grinding device 1 and additionally had a limited service life, resulting in the relatively high grinding costs per cam 2.

By way of example, with the retaining mandrel 3 according to the invention, it is also conceivable for the latter to be removed from the device 1 immediately after the grinding operation has been completed and to be positioned in axial alignment with a mounting camshaft of an internal combustion engine, whereupon the individual cams 2 are then each gripped by induction pliers, inductively heated and removed from the ceramic retaining mandrel 3 and positioned directly, i.e. without cooling and intermediate storage, on the camshaft. Since the ceramic retaining mandrel 3 is electrically non-conducting and therefore cannot be inductively heated, only the cam 2, but not the retaining mandrel 3, is inductively heated in the case of the device 1 according to the invention. In this case, the retaining mandrel 3 can only be heated by the transfer of heat from the cam 2 to the retaining mandrel 3. Since ceramic has a considerably lower thermal expansion compared to steel, even heating of the retaining mandrel 3 scarcely leads to thermal expansions thereof, however, as a result of which the cam 2 can always be removed from the retaining mandrel 3 considerably more efficiently than would be possible in the case of a retaining mandrel formed from steel. The high creep resistance of the retaining mandrel 3 according to the invention, combined with the accompanying long service life, is particularly advantageous, however. The retaining mandrel 3 according to the invention likewise has the positive feature that it has a high coefficient of friction, which is effective on its surface with respect to the cams 2 and which makes improved adhesion between the retaining mandrel 3 and the cams 2 possible and requires a smaller overlap between the retaining mandrel 3 and the cams 2. On account of the high modulus of elasticity, it is now possible to simultaneously grind a plurality of cams 2, in contrast to retaining mandrels known from the prior art, without having to fear that the grinding result will be impaired by sagging of the retaining mandrel 3. In the case of retaining mandrels known to date from the prior art, it was necessary to grind each cam 2 individually, i.e. to grind all cams 2 in succession, which prolonged the grinding time considerably and therefore also increased the grinding costs.

Even if the cams 2 to be ground are pressed onto a retaining mandrel 3 which is formed at least in certain regions from ceramic, it can be assumed that the service life thereof will be extremely long, since its strength and its modulus of elasticity are much higher than those of steel. Overall, it is thereby possible to considerably reduce the grinding costs and the grinding time using the device 1 according to the invention, the costs of the ceramic retaining mandrel 3 according to the invention, considered at least over the entire service life thereof, likewise being lower than the costs for comparable retaining mandrels formed from steel.

1. A device for grinding cams for a camshaft comprising: at least one retaining mandrel on which the cams are non-rotatably fixed during the grinding operation, and wherein the at least one retaining mandrel is formed at least in certain regions from ceramic.

2.-8. (canceled)

9. The device as claimed in claim 1, wherein the at least one retaining mandrel is formed at least in certain regions from a nitride ceramic.

10. The device as claimed in claim 9, wherein the nitride ceramic comprises silicon.

11. The device as claimed in claim 10, wherein the cams are arranged on the retaining mandrel by at least one of a form fit and force fit.

12. The device as claimed in claim 10, wherein the cams are at least one of thermally joined to the retaining mandrel and braced on the retaining mandrel.

13. The device as claimed in claim 10, wherein the cams are braced on the retaining mandrel via spacer rings arranged therebetween in the axial direction.

14. The device as claimed in claim 10, wherein at least certain regions of an outer side of the at least one retaining mandrel are at least one of knurled, have a multi-toothed profile, and have a tongue and groove connection.

15. The device as claimed in claim 10, wherein the at least one retaining mandrel is designed at least for simultaneously retaining at least two cams.

16. The device as claimed in claim 9, wherein the cams are arranged on the retaining mandrel by at least one of a form fit and force fit.

17. The device as claimed in claim 9, wherein at least certain regions of an outer side of the at least one retaining mandrel are at least one of knurled, have a multi-toothed profile, and have a tongue and groove connection.

18. The device as claimed in claim 9, wherein the at least one retaining mandrel is designed at least for simultaneously retaining at least two cams.

19. The device as claimed in claim 1, wherein the cams are arranged on the retaining mandrel by at least one of a form fit and force fit.

20. The device as claimed in claim 19, wherein at least certain regions of an outer side of the at least one retaining mandrel are at least one of knurled, have a multi-toothed profile, and have a tongue and groove connection.

21. The device as claimed in claim 19, wherein the at least one retaining mandrel is designed at least for simultaneously retaining at least two cams.

22. The device as claimed in claim 1, wherein at least certain regions of an outer side of the at least one retaining mandrel are at least one of knurled, have a multi-toothed profile, and have a tongue and groove connection.

23. The device as claimed in claim 22, wherein the at least one retaining mandrel is designed at least for simultaneously retaining at least two cams.

23. The device as claimed in claim 1, wherein the at least one retaining mandrel is designed at least for simultaneously retaining at least two cams.

25. A process for grinding cams of a camshaft comprising:
non-rotatably fixing the cams to a retaining mandrel, the retaining mandrel being formed at least in certain regions from ceramic, the cams being non-rotatably fixed by at least one of a force fit, form fit, and thermal joining,
removing the retaining mandrel from the grinding device,
heating each cam, and
fitting each cam onto the camshaft.

26. The process as claimed in claim 25, wherein after each cam has been removed from the retaining mandrel, each cam is fitted onto the camshaft without intermediate storage and cooling.
